(19) United States
(12) Patent Application Publication
(10) Pub. No.: US 2008/0098614 A1
(43) Pub. Date: May 1, 2008

(54) Lyophilization methods and apparatuses

(75) Inventors: Serguei A. Tchessalov, Andover, MA (US); Nicholas William Warne, Andover, MA (US)

Correspondence Address: KIRKPATRICK & LOCKHART PRESTON GATES ELLIS LLP;(FORMERLY KIRKPATRICK&LOCKHART NICHOLSON GRAHAM), STATE STREET FINANCIAL CENTER, ONE LINCOLN STREET, BOSTON, MA, 02111-2950, US

(73) Assignee: Wyeth, Madison, NJ (US)

(21) Appl. No.: 11/906,622

(22) Filed: Oct. 3, 2007

Related U.S. Application Data
(60) Provisional application No. 60/849,040, filed on Oct. 3, 2006.

(51) Int. Cl. F26B 5/06; F26B 19/00

(52) U.S. Cl. 34/284; 34/552

(57) ABSTRACT

A method and apparatus for optimizing the primary drying step of a lyophilization cycle of a biological or pharmaceutical material. In one aspect, the invention is a method for lyophilizing a material comprising the steps of calculating a designed primary drying cycle for the material based on a product temperature profile for the material and modifying both a chamber pressure and a shelf temperature according to a designed primary drying cycle during a primary drying step. In another aspect, the invention is an apparatus for lyophilizing a material according to a designed primary drying cycle comprising a computer-readable medium, a processor in electrical communication with the computer-readable medium, a chamber pressure module in electrical communication with the processor, and a shelf temperature module in electrical communication with the processor.

### RELATED APPLICATION DATA

This application claims priority to and the benefit of U.S. Provisional Patent Application Ser. No. 60/849,040, filed Oct. 3, 2006, the disclosures of which are incorporated herein by reference.

### FIELD OF THE INVENTION

The invention relates to the field of lyophilization or freeze-drying for the preservation of biological and pharmaceutical materials. In particular, the invention relates to a method of lyophilization in which a desired product temperature is maintained during the primary drying step of the lyophilization method by modifying the shelf temperature and/or the chamber pressure of the lyophilization chamber.

### BACKGROUND OF THE INVENTION

Lyophilization or freeze-drying is a process widely used in the pharmaceutical industry for the preservation of biological and pharmaceutical materials. In lyophilization, water present in a material is converted to ice during a freezing step and then removed from the material by direct sublimation under low-pressure conditions during a primary drying step. During freezing, however, not all of the water is transformed to ice. Some portion of the water is trapped in a matrix of solids containing, for example, formulation components and/or the active ingredient. The excess bound water within the matrix can be reduced to a desired level of residual moisture during a secondary drying step.

All lyophilization steps, freezing, primary drying and secondary drying, are determinative of the final product properties. However, the primary drying step is typically the longest and most expensive step in the process. Therefore, optimization of the primary drying step significantly improves both the economics and efficiency of the lyophilization process.

### SUMMARY OF THE INVENTION

Lyophilization is a very efficient but also a very expensive process for the preservation of biological and pharmaceutical materials. Lyophilization includes the sequential steps of freezing, primary drying, and secondary drying. The primary drying step is not only the longest step of the lyophilization process, but it is also the most sensitive to deviations in process parameters, including the process parameters of shelf temperature and chamber pressure.

Current lyophilization methods for biological and pharmaceutical materials maintain a constant shelf temperature and a constant chamber pressure throughout the primary drying step. Operation of laboratory-scale lyophilizers, pilot-scale lyophilizers and commercial-scale lyophilizers is simplified when a constant shelf temperature and a constant chamber pressure are maintained throughout the primary drying step.

It is desirable to decrease the length, and therefore the expense, of the primary drying step. According to various embodiments of the invention, the length of the primary drying step is decreased by maintaining the product temperature of the material at or just below the target temperature of the material.

In one aspect, the invention is a method for lyophilizing a material. The method comprises the step of modifying both a chamber pressure and a shelf temperature according to a designed primary drying cycle during a primary drying step.

In one embodiment, the method further comprises the step of generating a designed primary drying cycle for a material based on a product temperature profile for the material. In another embodiment, the method further comprises the step of calculating the product temperature profile for the material based on the cake resistance of the material. In a further embodiment, the method further comprises the step of calculating the product temperature profile for the material based on a vial heat transfer coefficient. In another embodiment, the product temperature profile is calculated using product temperature data obtained during a primary drying step conducted in a laboratory, pilot or commercial lyophilizer.

In one embodiment, the designed primary drying cycle maintains a temperature of the material at or below a target temperature of the material. In another embodiment, the designed primary drying cycle maintains the temperature of the material within about 15° C. of the target temperature of the material. In a further embodiment, the designed primary drying cycle maintains the temperature of the material within about 5° C. of the target temperature of the material. In another embodiment, the chamber pressure and the shelf temperature are modified simultaneously.

In additional embodiments, the material undergoing the designed primary drying cycle includes a biological agent, a pharmaceutical agent, a solute having a concentration of protein in solution in the range of about 1 mg/ml to 150 mg/ml, a solute having a concentration of protein in solution in the range of about 1 mg/ml to 50 mg/ml, a bulking agent selected from the group consisting of sucrose, glycine, sodium chloride, lactose and mannitol, a stabilizer selected from the group consisting of sucrose, trehalose, arginine, and sorbitol, and/or a buffer selected from the group consisting of tris, histidine, citrate, acetate, phosphate and succinate.

In further embodiments, the primary drying step of the designed primary drying cycle is conducted in a commercial-scale lyophilizer, a pilot-scale lyophilizer, or a laboratory-scale lyophilizer.

In another aspect, the invention is an apparatus for lyophilizing a material comprising a computer-readable medium adapted to record a designed primary drying cycle, a processor in electrical communication with the computer-readable medium and adapted to execute the designed primary drying cycle, a chamber pressure module in electrical communication with the processor and adapted to modify a pressure of a lyophilization chamber in response to an instruction received from the processor, and a shelf temperature module in electrical communication with the processor and adapted to modify a shelf temperature of a lyophilization chamber in response to an instruction received from the processor.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a graphical illustration of the process parameters and material characteristics of an exemplary primary drying step of a 4.5% sucrose solution wherein the shelf temperature remained constant at about −27° C. and the chamber pressure remained constant at about 53 mTorr.

FIG. 2 is a graphical illustration of the process parameters and material characteristics of an exemplary primary drying step of a material with a 10 mg/ml protein concentration wherein the shelf temperature remained constant at 0° C. and the chamber pressure remained constant at 50 mTorr.

FIG. 3 is a graphical illustration of the process parameters and material characteristics of an exemplary primary drying step of a material with a 50 mg/ml protein concentration at laboratory scale wherein the chamber pressure remained constant at about 50 mTorr and the shelf temperature was adjusted during the primary drying step in order to maintain a product temperature below the critical value.

FIG. 4 is a graphical illustration of the process parameters and material characteristics of an exemplary primary drying step of a material with a 10 mg/ml protein concentration wherein the chamber pressure remained constant at about 50 mTorr and the shelf temperature was adjusted during the primary drying step in order to maintain a product temperature below the critical value. A two-step shelf temperature program is designed for implementation of the lyophilization cycle at the commercial scale.

FIG. 5 is a graphical illustration of the process parameters and material characteristics of an exemplary primary drying step of a material with a 25 mg/ml protein concentration wherein the shelf temperature remained constant at about −25° C. and the chamber pressure was adjusted during the primary drying step.

FIG. 6 is a graphical illustration of the process parameters and material characteristics of an exemplary primary drying step of a material with a 10 mg/ml protein concentration wherein both the shelf temperature and the chamber pressure were adjusted during the primary drying step.

FIG. 7 is a graphical illustration of exemplary vial heat transfer coefficients as a function of the chamber pressure in an exemplary pilot lyophilizer.

FIG. 8 is a graphical illustration of an exemplary designed primary drying cycle.

FIG. 9 is a graphical illustration of exemplary effects of process variations on an estimated product temperature profile for a 5% sucrose solution in a commercial-scale pilot lyophilizer.

FIG. 10 illustrates exemplary data of the effects of process variations for the 5% sucrose solution in a commercial-scale pilot lyophilizer illustrated graphically in FIG. 9.

FIG. 11 is a schematic representation of a lyophilization apparatus according to an illustrative embodiment of the invention.

### DETAILED DESCRIPTION OF THE INVENTION

Lyophilization includes the sequential steps of freezing, primary drying, and secondary drying. The primary drying step, the longest and therefore most expensive step of the lyophilization process, is very sensitive to deviations in process parameters, including the process parameters of shelf temperature and chamber pressure.

Current lyophilization methods for biological and pharmaceutical materials maintain a constant shelf temperature and a constant chamber pressure throughout the primary drying step, which simplifies the primary drying step of the lyophilization process. However, constant process parameters of shelf temperature and chamber pressure throughout the duration of the primary drying step decrease the efficiency of the primary drying step and increase the cost of the primary drying step.

It is desirable to decrease the length, and therefore the expense, of the primary drying step. According to various embodiments of the invention, the length of the primary drying step is decreased by modifying the process parameters of shelf temperature and chamber pressure to maintain the product temperature of the material at or just below the target temperature of the material throughout the primary drying step. The product temperature of a material is the temperature of the material at any given time point during lyophilization. When measured in-time using a pilot-scale lyophilizer or a laboratory-scale lyophilizer, the product temperature of a material is often measured at a position within the material just above the bottom of the vial. The target temperature of a material is the desired temperature of the material at any given time point during lyophilization and is about 2-3° C. below the collapse temperature of the material. The collapse temperature of a material is the temperature during freezing resulting in the collapse of the structural integrity of the material.

The relationship between heat and mass balance during the primary drying step are described by the following equation:

$$\frac{\partial m}{\partial t} = \frac{{S}_{i n} * {( {P}_{Subl} - {P}_{Chamber} )}_{i}}{{R ( h )}_{i}} = \frac{{S}_{out} * {K}_{V} * ( {T}_{Shelf} - {T}_{product} )}{Δ {H}_{S}} \qquad Equation 1$$

where

$$\frac{\partial m}{\partial t}$$

—sublimation rate,

Kᵥ—vial heat transfer coefficient,

T_{shelf}—shelf temperature (typically inlet temperature of heat transfer liquid),

T_{product}—product temperature (typically measured just above the vial bottom),

ΔH_{S}—specific heat of sublimation,

Sₒᵤₜ—external surface area of vial,

Sᵢₙ—internal surface area of vial,

P_{subl}—pressure of water vapor over sublimation surface,

P_{chamber}—chamber pressure, and

R(h)ᵢ—dry cake resistance at dry layer height (h)ᵢ.

During the primary drying step, the specific heat of sublimation (ΔH_{S}), the external surface of the vial (Sₒᵤₜ), the internal surface of the vial (Sᵢₙ), and the vial heat transfer coefficient (Kᵥ) remain relatively constant. However, as water is removed from the material and as the sublimation front moves gradually from the top of the vial to the bottom of the vial, the total cake resistance gradually increases due to the development of a dry layer within the material.

Cake resistance is the resistance of dry porous material to the flow of water vapor generated during sublimation. In general, cake resistance depends on the concentration of solids in the material and the nature of the material undergoing lyophilization. Cake resistance increases as the concentration of solids in the material increases.

However, the solids concentration is not the only factor affecting cake resistance. Materials subject to lyophilization, including, for example, biological agents (e.g., proteins, peptides and nucleic acids) and pharmaceutical agents (e.g., small molecules), often include bulking agents, stabilizers, buffers and other product formulation components in addition to a solvent. Exemplary bulking agents include sucrose, glycine, sodium chloride, lactose and mannitol. Exemplary stabilizers include sucrose, trehalose, arginine and sorbitol. Exemplary buffers include tris, histidine, citrate, acetate, phosphate and succinate. Exemplary additional formulation components include antioxidants, surface active agents and tonicity components. Formulation components can affect the cake resistance of a material and, therefore, the process parameters necessary to efficiently lyophilize a selected material. Exemplary solvents include water, organic solvents and inorganic solvents. An exemplary material, a 5% sucrose solution, has a lower relative cake resistance than a mannitol-sucrose buffer having the same solids concentration. Sucrose is susceptible to partial collapse at temperatures close to −32° C., resulting in the formation of larger pores and, therefore, less resistance to water vapor flow. This may account for the relatively small cake resistance of a 5% sucrose solution as compared to a mannitol-based formulation. As a result, the product temperature of a 5% sucrose solution does not increase more than 5° C. during the primary drying step of lyophilization.

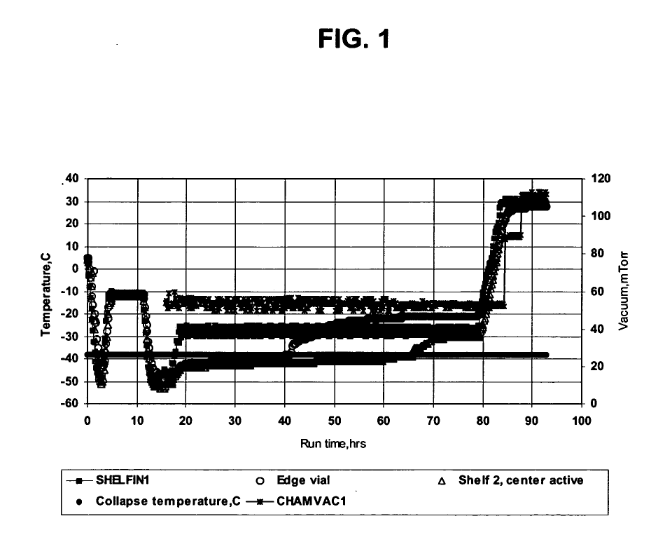

FIG. 1 is a graphical illustration of the process parameters and material characteristics of an exemplary primary drying step of a 4.5% sucrose solution wherein the shelf temperature remained constant at −27° C. and the chamber pressure remained constant at 53 mTorr. According to the exemplary primary drying step illustrated in FIG. 1, the product temperature of the material in the vial positioned in the center of the shelf increased from −44° C. to −39° C. and the product temperature of the material in the vial positioned at the edge of the shelf increased from −42° C. to −39° C. The exemplary 5° C. increase in product temperature is considered small. In the case of the exemplary 5° C. increase in product temperature, the increased complexity of modifying the shelf temperature and/or the chamber pressure of the lyophilizer may outweigh the benefits of decreasing the duration of the primary drying step. Therefore, the process parameters of constant shelf temperature and constant chamber pressure are reasonable for this material.

In practice, a 5° C. increase in product temperature during the primary drying step of lyophilization is exemplary of a reasonable rise in temperature. Therefore, in the case of a 5% sucrose solution, for example, it is not necessary to change the shelf temperature and/or chamber pressure process parameters during the primary drying step of lyophilization. Similarly, it is not necessary to change the shelf temperature and/or chamber pressure process parameters during the primary drying stage of similar materials with similarly low protein concentration and relatively small, for example less than 5%, solids concentration.

However, as the solids concentration in a material increases, for example, as the protein concentration increases, the cake resistance of the material also increases. A higher solids concentration also results in a greater increase in product temperature during a primary drying step wherein the shelf temperature and the chamber pressure remain constant.

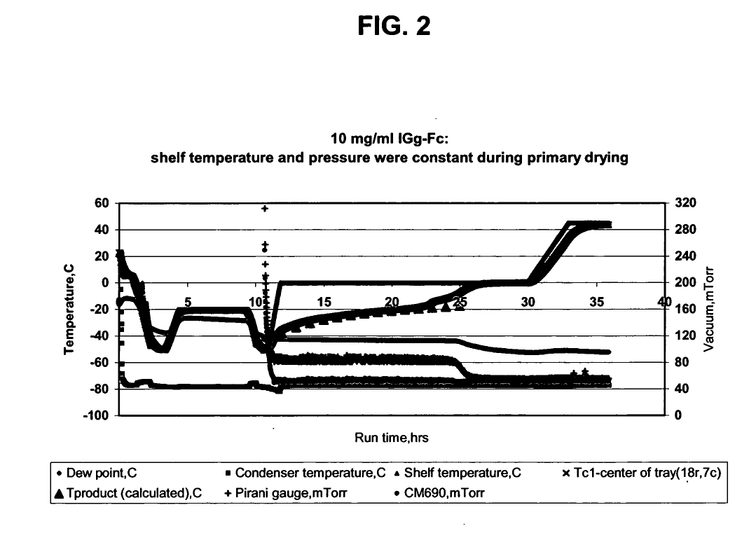

FIG. 2 is a graphical illustration of the process parameters and material characteristics of an exemplary primary drying step of a material with a 10 mg/ml protein concentration wherein the shelf temperature remained constant at 0° C. and the chamber pressure remained constant at 50 mTorr. According to the exemplary primary drying step of the higher protein concentration material, the product temperature of the material increased from −40° C. to −18° C. The exemplary 22° C. increase in product temperature is considered rather large and economically unacceptable. Moreover, the product temperature of the material increased above its target temperature of −20° C. Therefore, maintaining the chosen process parameters at constant values is considered economically unacceptable for this high protein concentration material.

The product temperature of the exemplary higher protein concentration material illustrated in FIG. 2 can be maintained below the target temperature of −20° C. during the primary drying step of lyophilization by resetting the shelf temperature and/or the chamber pressure process parameters to constant, but relatively lower, values. Constant process parameters of shelf temperature and chamber pressure can be calculated using Equation 1 such that the product temperature never exceeds the target temperature at the end of the primary drying step. Although selecting a constant shelf temperature and a constant chamber pressure for lyophilization of higher protein concentration materials or higher cake resistance materials is a safe and simple solution from a manufacturing perspective, this method results in a very long and therefore very expensive primary drying step.

Analysis of Equation 1 suggests, however, that maintaining a constant shelf temperature and a constant chamber pressure is not the most economical method of conducting the primary drying step for higher protein concentration materials or higher cake resistance materials. Alternatively, either and/or both of the process parameters of shelf temperature and chamber pressure can be modified during the course of the primary drying step to maintain an optimal product temperature of a material during the primary drying step.

A mathematical model can be constructed based on Equation 1. An exemplary mathematical model describes the relationship between the process parameters of chamber pressure and shelf temperature, the dry product cake resistance, the vial heat transfer coefficient, and the product temperature. The mathematical model can be utilized to calculate a product temperature profile for a selected material. First, the mathematical model can be used to estimate the product temperature of a specific material with known product properties at each time point measurement of the process parameters during the primary drying step. Following estimation of the product temperature, the sublimation rate at each time point of the primary drying step can be calculated using the mathematical model and plotted as a function of time. The total sublimated mass of water at each point of the process can be estimated by integrating the sublimation rate profile until the calculated value of sublimated water reaches the total water content of the material. The optimal product temperature profile can be maintained throughout the course of the primary drying step for a specific material by manipulating the process parameters of shelf temperature and/or chamber pressure during the primary drying step.

According to a preferred embodiment, the mathematical model based on Equation 1 described above is used to calculate a product temperature profile for a selected material. Any mathematical model which sufficiently describes the product temperature profile during the primary drying step can be used to generate the designed primary drying cycle. A preferred mathematical model calculates a product temperature profile within 1° C. of the actual product temperature and at or within 2° C. below the target temperature of the material during the course of the primary drying step.

The product temperature profile obtained in the laboratory, pilot or commercial primary drying cycle is used to generate a designed primary drying cycle (based on calculated cake resistance and vial heat transfer coefficients) wherein the product temperature of the material is maintained at a substantially constant temperature and at or just below the target temperature of the selected material during the course of the primary drying step. According to a preferred embodiment, the designed primary drying cycle maintains the product temperature of the material within about 1° C. of the target temperature during the course of the primary drying step. According to another embodiment, the designed primary drying cycle maintains the product temperature of a material with a low collapse temperature, for example, a collapse temperature of about −30° C., within about 5° C. of the target temperature. An exemplary material with a low collapse temperature is sucrose. According to another embodiment, the designed primary drying cycle maintains the product temperature of a material with a relatively higher collapse temperature, for example, a collapse temperature of about −5° C. to −20° C., within about 15° C. of the target temperature.

The target temperature is also described as the critical temperature of the material, a temperature about 2-3° C. below the collapse temperature of the material. The critical temperature of a material is the temperature above which distinct liquid and gas phases do not exist. As the critical temperature is approached, the properties of the gas and liquid phases become the same resulting in only one phase: the supercritical fluid. Above the critical temperature a liquid cannot be formed by an increase in pressure, but with enough pressure a solid may be formed. Depending on the material, the critical temperature of a material can be the same as the collapse temperature of the material. Maintaining the material at or just below the target temperature of the material results in the shortest and most efficient primary drying step.

According to one embodiment, the product temperature is maintained at or just below the target temperature of the material by first increasing the shelf temperature to the maximum allowed temperature of the lyophilizer. According to one exemplary embodiment, the maximum allowed temperature of the lyophilizer is in the range of about −30° C. to 60° C., more preferably about 0° C. to 60° C., and most preferably about 20° C. to 60° C.

At the initiation of the primary drying step, cake resistance is not a significant factor in the efficiency of the primary drying rate or sublimation rate; the product temperature is relatively low; and the product temperature depends, for the most part, on chamber pressure. As water is removed from the material, product dry layer begins to form. Beginning at the point when product dry layer begins to form, the product temperature begins to gradually increase until the product temperature reaches the target temperature of the material. At the point when the material reaches its target temperature, either the shelf temperature or the chamber pressure or both process parameters are simultaneously adjusted to maintain the material at a temperature at or just below the target temperature of the material.

Continuing for the remainder of the primary drying step, the shelf temperature and the chamber pressure are monitored and, optionally and when necessary, adjusted or modified to maintain the product temperature at or just below the target temperature of the material. It is understood that the terms adjust or modify, when applied to a process parameter, contemplate increasing the value of the parameter and/or decreasing the value of the parameter.

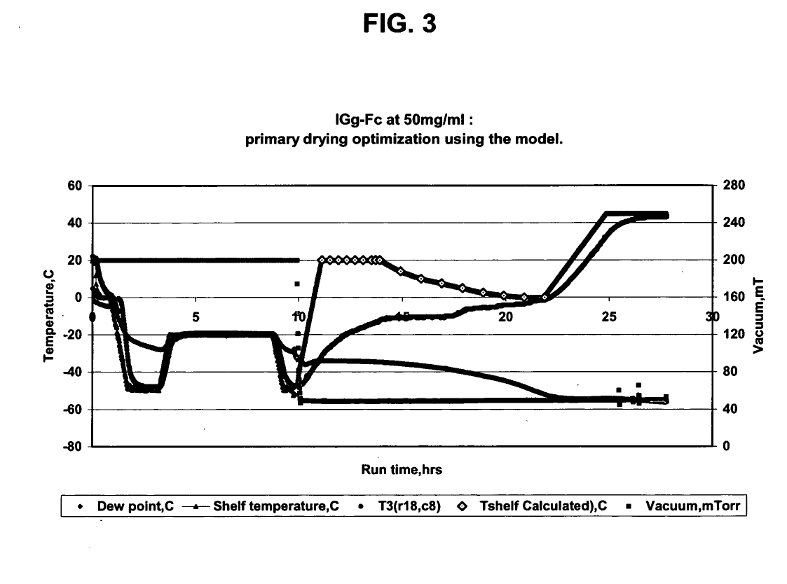

FIG. 3 is a graphical illustration of the process parameters and material characteristics of an exemplary primary drying step of a material with a 50 mg/ml protein concentration wherein the chamber pressure remained constant at about 50 mTorr and the shelf temperature was adjusted during the primary drying step. According to the exemplary primary drying step wherein the chamber pressure remained constant and the shelf temperature was modified, the shelf temperature was gradually increased to about 20° C. at a rate of about 1 deg/min. Once the shelf temperature approached the initial high temperature of about 20° C., the shelf temperature was maintained at this temperature for about 3 hours. After this period of drying, the shelf temperature was gradually decreased to maintain the target temperature of the material at or just below about −10° C.

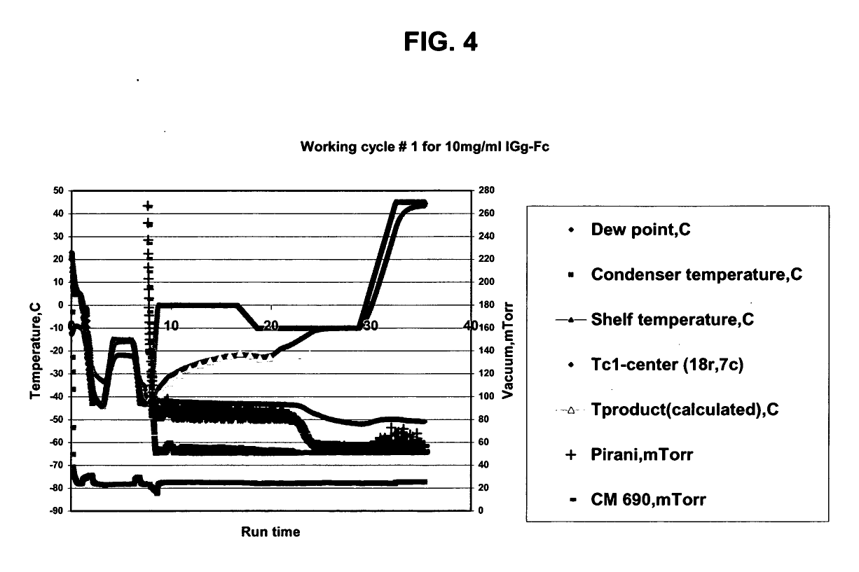

FIG. 4 is a graphical illustration of the process parameters and material characteristics of an exemplary primary drying step of a material with a 10 mg/ml protein concentration wherein the chamber pressure remained constant at about 50 mTorr and the shelf temperature was adjusted during the primary drying step. According to the exemplary primary drying step wherein the chamber pressure remained constant and the shelf temperature was modified, the shelf temperature was gradually increased to about 0° C. Once the product temperature approached the target temperature of about −20° C., the shelf temperature was gradually decreased to about −10° C. and maintained at this temperature until the end of the primary drying step. The product temperature was maintained at or below the target temperature during the primary drying step.

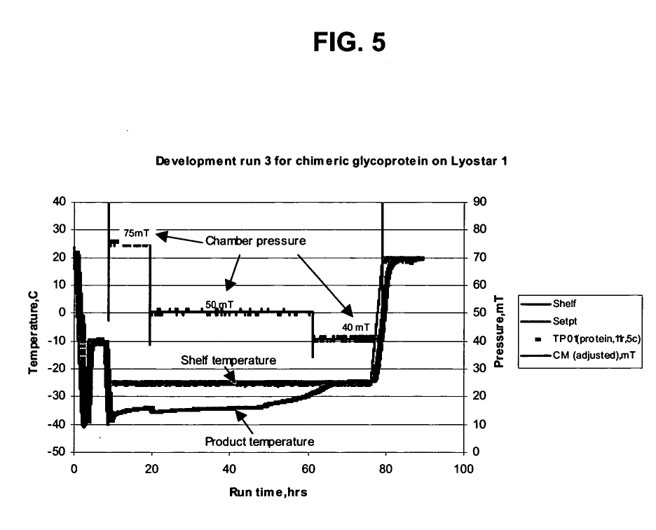

FIG. 5 is a graphical illustration of the process parameters and material characteristics of an exemplary primary drying step of a material with a 25 mg/ml protein concentration wherein the shelf temperature remained constant at about −25° C. and the chamber pressure was adjusted during the primary drying step. According to the exemplary primary drying step wherein the shelf temperature remained constant and the chamber pressure was modified, the chamber pressure was initially set at a pressure of about 75 mTorr. A chamber pressure higher than about 50 mTorr was chosen at the beginning of the primary drying step when the sublimation rate has its highest value. A relatively lower shelf temperature of about −25° C. was chosen at the beginning of the primary drying step, when the cake resistance is relatively low, to maintain the product temperature below the target temperature of the material, about −31.4° C. Once the product temperature approached about −34° C., the chamber pressure was decreased to about 50 mTorr to maintain the product temperature below the target temperature. During the final portion of the primary drying step, the chamber pressure was again decreased, to about 40 mTorr, to maintain the product temperature below the target temperature for the remainder of the primary drying step.

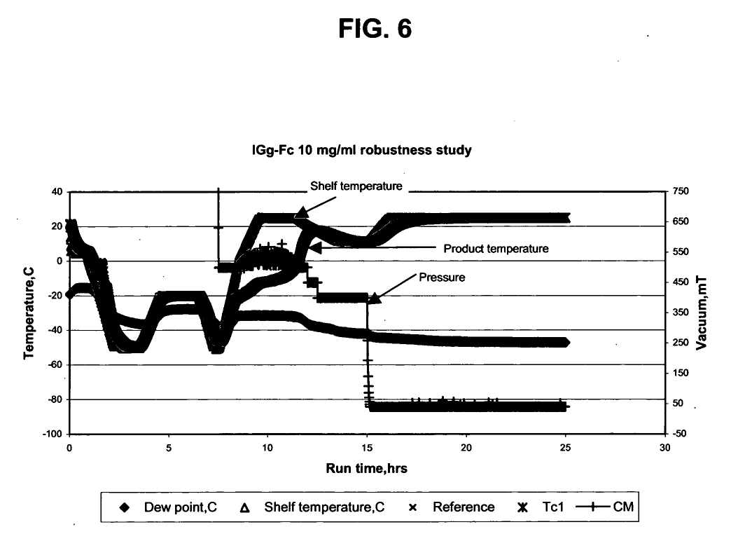

FIG. 6 is a graphical illustration of the process parameters and material characteristics of an exemplary primary drying step of a material with a 10 mg/ml protein concentration wherein both the shelf temperature and the chamber pressure were adjusted during the primary drying step. According to the exemplary primary drying step wherein both the shelf temperature and the chamber pressure were modified, both process parameters were modified simultaneously at three time points. According to another embodiment, the shelf temperature is modified before and/or after the chamber pressure is modified.

Due to sterility requirements and the automation of load and unload processes in commercial biological and pharmaceutical material lyophilization facilities, it is not possible to introduce in-time product temperature sensors into modern commercial-scale lyophilizers. Therefore, it is not possible to monitor the product temperature and, in response, modify the shelf temperature and/or chamber pressure to maintain an optimal product temperature profile. However, the mathematical model can be used to calculate and/or to validate a designed primary drying cycle for a specific material. A commercial-scale or pilot-scale lyophilizer then can be programmed according to the designed primary drying cycle to modify the shelf temperature and/or the chamber pressure by a predetermined change in value at one or more predetermined time points in the primary drying cycle to optimize the primary drying step for the selected material.

During the primary drying cycle, three programmed parameters—shelf temperature, chamber pressure and time—yield the resulting product temperature profile. These programmed parameters also affect lyophilizer performance, including the rate of sublimation and the rate and efficiency of heat transfer from the shelf to the vial. The optimal process parameters can be measured and/or calculated using a laboratory-scale lyophilizer with an in-time product temperature sensor to create a designed primary drying cycle for pilot-scale or commercial-scale lyophilization of a selected material.

According to one embodiment, prior to generating in-time process parameter measurements, product properties of the selected material can be defined. Exemplary product properties include product water content, liquid product density, frozen product density, and product cake resistance as a function of dry product height. Vial properties also can be defined. Exemplary vial properties include vial filling volume, vial geometry, and vial heat transfer coefficients as a function of pressure. Lyophilization chamber properties also can be defined. Exemplary lyophilization chamber properties include the heat radiation from the lyophilizer walls or door to the product, also known as edge effect.

Knowing some or all of the above-identified product, vial and/or chamber properties, additional lyophilization process properties can be calculated using equations known to one of skill in the art. Exemplary additional properties that can be calculated include the heat flux through the layer of frozen material at any given time, the total heat flux for sublimation, the sublimation rate for an individual vial, the sublimation rate as a function of the primary drying time, pressure over the sublimation surface, the temperature of the sublimation surface at various time points in the cycle, the amount of sublimated ice at various time points in the cycle, the thickness of the frozen layer at the beginning of primary drying and at various additional time points in the cycle (also described as the cake height), and the total sublimation cycle time.

According to a preferred embodiment, a designed primary drying cycle is created by measuring the process parameters and product properties of a selected material using an in-time product temperature sensor in a laboratory-scale lyophilizer over the course of at least one primary drying cycle followed by optimization of the process parameters according to the mathematical model described in greater detail above. The primary drying cycle is optimized when the product temperature of the material is maintained at or just below, within about 1° C. of, the target temperature of the material during the primary drying step.

Using the mathematical model, an estimation is created of the product temperature profile for the subsequent cycles as a function of the process parameters and product properties throughout the course of the entire primary drying step for the selected material. Using the product temperature profile estimation and known characteristics of the pilot-scale or commercial-scale lyophilizer, including vial heat transfer coefficient and edge effect, a primary drying cycle can be designed for a pilot-scale or commercial-scale lyophilizer for efficiently lyophilizing a selected material.

According to one embodiment, the chamber pressure of a lyophilizer is adjusted to known values of pressure during the course of at least one primary drying cycle and a product temperature profile is created by optimizing an appropriate and optionally adjustable shelf temperature using the mathematical model. According to another embodiment, the shelf temperature of a lyophilizer is adjusted to known values of temperature during the course of at least one primary drying cycle and a product temperature profile is created by optimizing an appropriate and optionally adjustable chamber pressure using the mathematical model. According to a further embodiment, a product temperature profile is created by optimizing an appropriate and optionally adjustable chamber pressure and shelf temperature using the mathematical model wherein only the product properties of the material and the vial are known.

Vial heat transfer coefficients are calculated from the weight loss during sublimation during a short period of time. Vial heat transfer coefficients can be calculated using the following equation:

$${K}_{V} = \frac{2 Δ {H}_{S} Δ {m}_{average}}{{S}_{out} {\sum }_{i = 1}^{n} ( Δ {T}_{i} + Δ {T}_{i - 1} ) ( {t}_{i} - {t}_{i - 1} )} \qquad Equation 2$$

where

K_{V}—heat transfer coefficient from heat transfer fluid to product in vial;

ΔH_{S}—heat of ice sublimation;

Δm—average vial weight loss due to ice sublimation;

Sₒᵤₜ—surface area of the bottom of the vial;

ΔTᵢ—actual temperature gradient between product and shelf at the i time point; and

tᵢ—any given (recorded) time point during sublimation of ice.

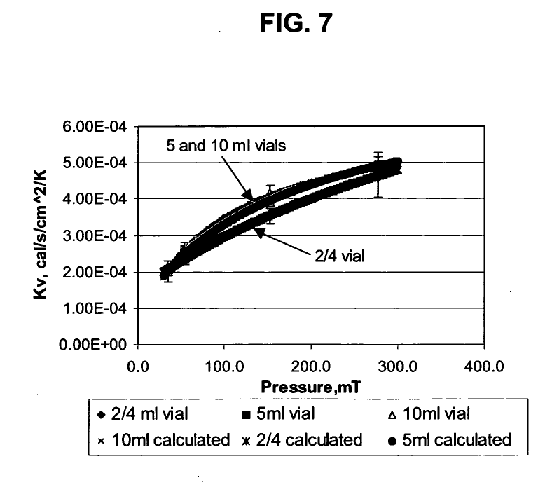

According to one exemplary lyophilizer, vial heat transfer coefficients as a function of chamber pressure were measured for three sizes of commonly used tubing vials, both as vials in the center of the pilot-scale lyophilizer and as vials at the edge of the lyophilizer. FIG. 7 is a graphical illustration of exemplary vial heat transfer coefficients as a function of the chamber pressure in an exemplary pilot lyophilizer. In all cases in the exemplary trials, the heat transfer coefficients in the commercial-scale pilot lyophilizers were lower than the heat transfer coefficients measured in the laboratory-scale lyophilizers.

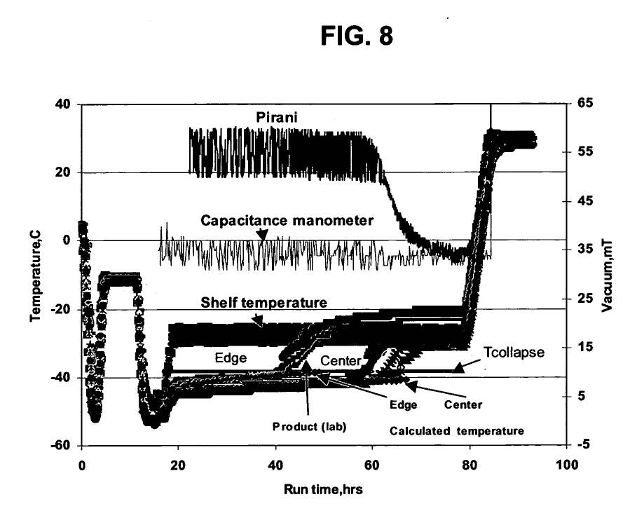

An exemplary designed primary drying cycle was created by inputting measured values into the mathematical model based on Equation 1, described in greater detail above. FIG. 8 is a graphical illustration of an exemplary designed primary drying cycle. The predicted product temperature profile based on the designed primary drying cycle in the commercial-scale pilot lyophilizer was in agreement with the measured product temperature values during laboratory-scale lyophilization of the same selected material, validating the designed primary drying cycle.

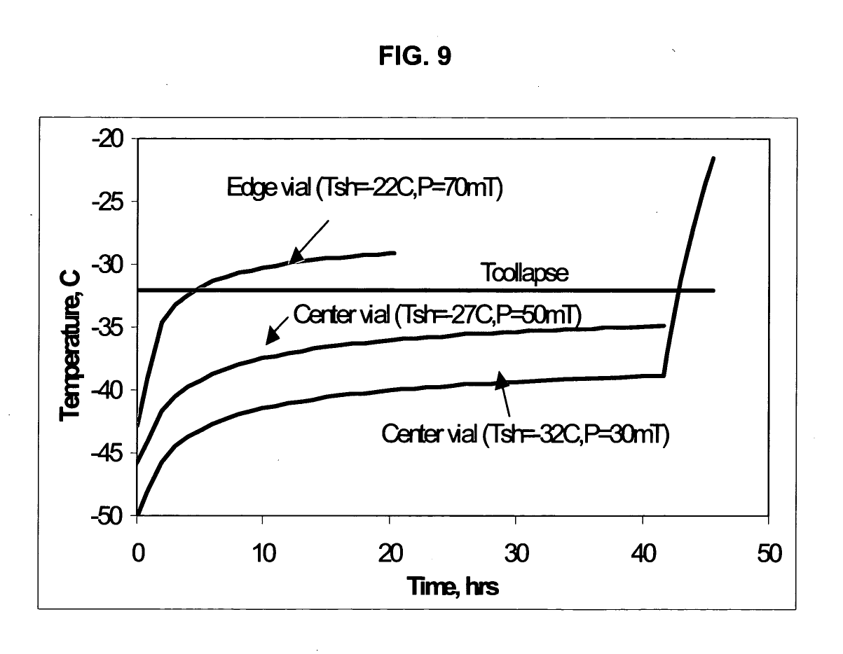

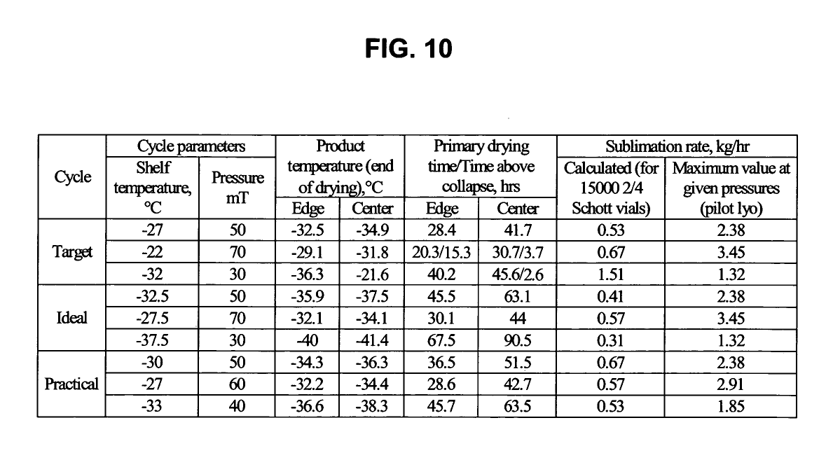

The mathematical model based on Equation 1 was further used to assess the impact of process deviations on the product temperature profile during the designed primary drying cycle to assess designed primary drying cycle robustness. FIG. 9 is a graphical illustration of exemplary effects of process variations on an estimated product temperature profile for a 5% sucrose solution in a pilot-scale lyophilizer. According to the exemplary embodiments, the heat flux to the edge of the vials was assumed to be 2-fold higher than for the center vials. Assuming that the material can tolerate a maximum deviation in shelf temperature of 5° C. and a maximum deviation in chamber pressure of 20 mTorr, two worst case scenarios are illustrated in FIG. 9. The exemplary estimated product temperature profile is illustrated as the center curve. The upper curve illustrates exemplary edge vials, which are shown to dry substantially above the target or collapse temperature. The lower curve illustrates exemplary center vials, which are shown to not complete the primary drying step at the end of the designed primary drying cycle. FIG. 10 illustrates exemplary data of the effects of process variations for the 5% sucrose solution in a pilot-scale lyophilizer illustrated graphically in FIG. 9.

According to one embodiment, the designed primary drying cycle modifies shelf temperature at least once during the course of the primary drying step. According to another embodiment, the designed primary drying cycle modifies chamber pressure at least once during the course of the primary drying step. According to a further embodiment, the designed primary drying cycle modifies each of the shelf temperature and the chamber pressure at least once during the course of the primary drying step.

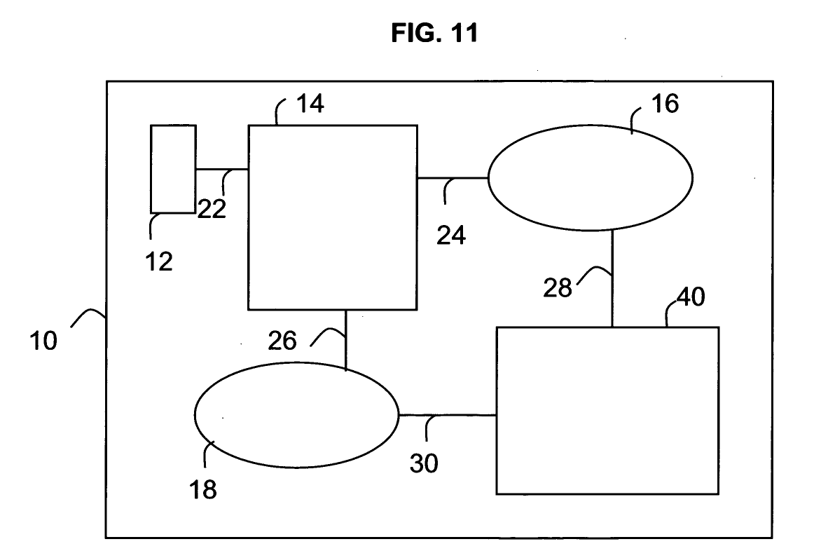

In another aspect, the invention is a commercial-scale lyophilizer, a pilot-scale lyophilizer, or a laboratory-scale lyophilizer programmed to perform a designed primary drying cycle for a selected material. FIG. 11 is a schematic representation of a lyophilizer 10 according to an illustrative embodiment of the invention.

With reference to FIG. 11, according to one embodiment, the lyophilizer 10 is adapted for lyophilizing a selected biological or pharmaceutical material (not shown) in a lyophilization chamber 40 and comprises a computer-readable medium 12, a processor 14, a chamber pressure module 16 and a shelf temperature module 18. The computer-readable medium 12 is adapted to record a designed primary drying cycle. The processor 14 is in electrical communication 22 with the computer-readable medium 12 and is adapted to execute the designed primary drying cycle. The chamber pressure module 16 is in electrical communication 24 with the processor 14 and is in electrical communication 28 with the lyophilization chamber 40. The chamber pressure module 16 is adapted to modify the pressure of the lyophilization chamber 40 in response to an instruction received from the processor 14. The shelf temperature module 18 is in electrical communication 26 with the processor 14 and is in electrical communication 30 with the lyophilization chamber 40. The shelf temperature module 18 is adapted to modify the shelf temperature of the lyophilization chamber 40 in response to an instruction received from the processor 14.

According to one embodiment of the programmed lyophilizer, the lyophilizer is programmed to modify the shelf temperature at least once during the primary drying step. According to another embodiment, the lyophilizer is programmed to modify the chamber pressure at least once during the primary drying step. According to a further embodiment, the lyophilizer is programmed to modify each of the shelf temperature and the chamber pressure at least once during the primary drying step.

The invention may be embodied in other specific forms without departing from the spirit or essential characteristics thereof. The present embodiments are therefore to be considered illustrative and not restrictive, the scope of the invention being indicated by the appended claims rather than by the foregoing description, and all changes which come within the meaning and range of equivalency of the claims are therefore intended to be embraced therein.

1. A method for lyophilizing a material comprising the step of modifying both a chamber pressure and a shelf temperature according to a designed primary drying cycle during a primary drying step.

2. The method of claim 1 further comprising the step of generating a designed primary drying cycle for the material based on a product temperature profile for the material.

3. The method of claim 2 further comprising the step of calculating the product temperature profile for the material based on a cake resistance of the material.

4. The method of claim 2 further comprising the step of calculating the product temperature profile for the material based on a vial heat transfer coefficient.

5. The method of claim 2 wherein the product temperature profile is calculated using product temperature data obtained during a primary drying step conducted in a laboratory, pilot or commercial lyophilizer.

6. The method of claim 1 wherein the designed primary drying cycle maintains a temperature of the material at or below a target temperature of the material.

7. The method of claim 1 wherein the designed primary drying cycle maintains a temperature of the material within about 15° C. of a target temperature of the material.

8. The method of claim 7 wherein the designed primary drying cycle maintains the temperature of the material within about 5° C. of the target temperature of the material.

9. The method of claim 1 wherein the chamber pressure and the shelf temperature are modified simultaneously.

10. The method of claim 1 wherein the material comprises a biological agent.

11. The method of claim 1 wherein the material comprises a pharmaceutical agent.

12. The method of claim 1 wherein the material comprises a solute having a concentration of protein in solution in the range of about 1 mg/ml to 150 mg/ml.

13. The method of claim 1 wherein the material comprises a solute having a concentration of protein in solution in the range of about 1 mg/ml to 50 mg/ml.

14. The method of claim 1 wherein the material comprises a bulking agent selected from the group consisting of sucrose, glycine, sodium chloride, lactose and mannitol.

15. The method of claim 1 wherein the material comprises a stabilizer selected from the group consisting of sucrose, trehalose, arginine and sorbitol.

16. The method of claim 1 wherein the material comprises a buffer selected from the group consisting of tris, histidine, citrate, acetate, phosphate and succinate.

17. The method of claim 1 wherein the primary drying step is conducted in a commercial-scale lyophilizer.

18. The method of claim 1 wherein the primary drying step is conducted in a pilot-scale lyophilizer.

19. The method of claim 1 wherein the primary drying step is conducted in a laboratory-scale lyophilizer.

20. An apparatus for lyophilizing a material comprising:
a) a computer-readable medium adapted to record a designed primary drying cycle;
b) a processor in electrical communication with the computer-readable medium and adapted to execute the designed primary drying cycle;
c) a chamber pressure module in electrical communication with the processor and adapted to modify a pressure of a lyophilization chamber in response to an instruction received from the processor; and
d) a shelf temperature module in electrical communication with the processor and adapted to modify a shelf temperature of a lyophilization chamber in response to an instruction received from the processor.
